(19) United States
(12) Patent Application Publication
(10) Pub. No.: US 2013/0297470 A1
(43) Pub. Date: Nov. 7, 2013

(54) Method To Open And Manage Multiple Term Deposit Products, Each Tied To An Individual Savings Objective, Within One Account

(71) Applicant: SMARTYPIG, L.L.C.D.B.A. SOCIAL MONEY, West Des Moines, IA (US)

(72) Inventor: Jon M. Gaskell, II, West Des Moines, IA (US)

(73) Assignee: SmartyPig, L.L.C.d.b.a. Social Money, West Des Moines, IA (US)

(21) Appl. No.: 13/875,758

(22) Filed: May 2, 2013

Related U.S. Application Data
(60) Provisional application No. 61/641,334, filed on May 2, 2012.

(51) Int. Cl. G06Q 40/02

(52) U.S. Cl. CPC G06Q 40/02
USPC 705/35

(57) ABSTRACT

The method of opening and managing multiple term deposit products where each product is tied to an individual savings objective and exists within a single term deposit account having a management software interface that is integrated with a financial institution to permit the financial institution to offer and manage multiple term deposit products.

### CROSS REFERENCE TO RELATED APPLICATION

This application claims the benefit of U.S. Provisional Application No. 61/641,334 filed May 2, 2012.

### BACKGROUND OF THE INVENTION

This invention is directed toward a method of opening and managing multiple term deposit products, each tied to an individual savings objective, all which exist within one single account.

As the Internet and online banking have become more prevalent, there exists a need to offer multiple term deposit products through online accounts. The multiple term deposit products for individual savings objectives would be most efficiently managed by the financial institution if they were able to be within one account. Therefore there exists a need to offer multiple term deposit products tied to individual savings objectives, within one account.

Therefore, an object of the present invention is to provide a method for financial institutions to allow their customers to open and manage multiple term deposit products within one account.

A further objective of this invention is to provide a method where individual savings objectives can be assigned to each of the individual term deposit products.

These and other objectives will be apparent to one skilled in the art based upon the following written description, drawings and claims.

### BRIEF SUMMARY OF THE INVENTION

The method of opening and managing multiple term deposit products, each tied to an individual savings objective, all which exist within one single account, includes a term deposit account having a user software interface. The user interface allows customers to open a multiplicity of term deposit products within one term deposit account through the user software interface. The user software interface also allows individual savings objectives to be tied to each of the individual term deposit products.

A management software interface interacts with the bank through a variety of files and web service calls, and ultimately supplies the bank with the ability to manage the individual term deposit products within a single term deposit account. Through this process the term deposits are issued by the financial institution and the customer relationship is solely owned by the financial institution. It is the financial intuition who also has the relationship with the provider of the user software interface.

### BRIEF DESCRIPTION OF THE DRAWINGS

FIG. 1 is a schematic view of the environment of a method of opening and managing multiple term deposit accounts; and

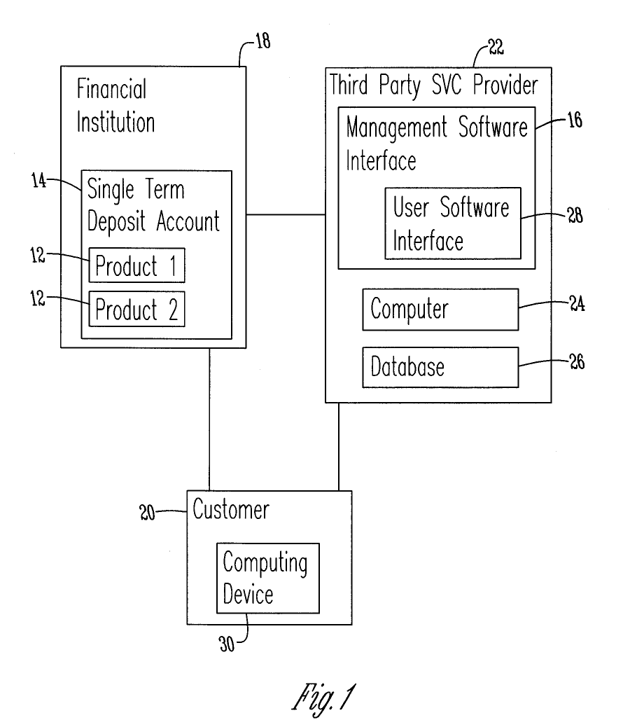

FIG. 2 is a flow diagram of a method of opening and managing multiple term deposit accounts.

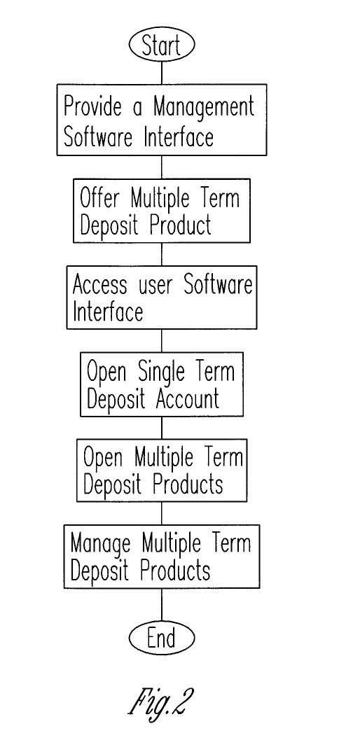

### DETAILED DESCRIPTION OF THE PREFERRED EMBODIMENTS

A system 10 for managing multiple term deposit products 12 within a single term deposit account 14 includes a management software interface 16 accessible over an electronic network via the internet by a financial institution 18 and the financial institution's customers 20.

The management software interface 16, provided by a third party service provider 22 is connected to a computer 24 having a database 26. The management software interface 16 includes the technology needed to open and manage multiple term deposit accounts 12 within a single term deposit account 14.

Included in the technology of the management software interface 16 is a user software interface 28. The user software interface 28 allows the third party service provider 22 to connect via the electronic network with the financial institution 18 to provide the data and technology through a series of web calls and files that permits the financial institution to provide multiple term deposit products 12 through a single term deposit account 14.

In operation, customers 20 access the user software interface 28 via the electronic network using any type of personal computing device 30. The user software interface 28 is comprised of content generated by the financial institution 18 and/or the third party service provider 22. Through the user software interface 28, the customer 20 opens a term deposit account 14, tie a savings objective and target date to the account 14, contribute to the account 14, and close the account 14. Based upon parameters set by the financial institution 18, the customer 20 earns a high interest rate due to the term structure of the account.

The customer 20 may also open multiple term deposit accounts 12 within the single saving account 14. Through the management software interface 16, the financial institution may manage the multiple term deposit products 12 within account 14 as sub accounts.

What is claimed is:

1. A method of opening and managing multiple term deposit products, comprising the steps of:
providing a management software interface to a financial institution via an electronic network wherein the management software interface is connected to a computer and has a user software interface;
accessing the user software interface via the electronic network by a customer of the financial institution;
opening a single term deposit account through the user software interface;
opening multiple term deposit products within the single term deposit account through the user software interface; and
wherein the management software interface manages the multiple term deposit products within the single term deposit account based upon the financial institution's instructions.

2. The method of claim 1 wherein the customer manages the single term deposit account through the user software interface.

3. The method of claim 2 wherein the financial institution generates content for the user software interface.
